(19) United States
(12) Patent Application Publication
(10) Pub. No.: US 2026/0042410 A1
(43) Pub. Date: Feb. 12, 2026

(54) IMPACT DETECTION WITH DEPLOYABLE BODY PANEL

(71) Applicant: Ford Global Technologies, LLC, Dearborn, MI (US)

(72) Inventors: Cortney Stancato, Novi, MI (US); Haiyan Zhao, Novi, MI (US); Hubert Szawarski, Waterford, MI (US); Richard Edward Ruthinowski, Taylor, MI (US); Heba Abdallah, Dearborn Heights, MI (US)

(73) Assignee: Ford Global Technologies, LLC, Dearborn, MI (US)

(21) Appl. No.: 18/795,322

(22) Filed: Aug. 6, 2024

(51) Int. Cl. B60R 21/0136; B60R 3/00; B60R 3/02; B60R 21/0134

(52) U.S. Cl. CPC B60R 21/0136; B60R 3/002; B60R 3/02; B60R 21/0134

(57) ABSTRACT

A computer includes a processor and memory storing instructions executable by the processor to: predict a potential impact to a vehicle; in response to prediction of a potential impact, move a deployable body panel of the vehicle from a stowed position to a deployed position; and with the deployable body panel in the deployed position, detect impact of an object with the deployable body panel.

### BACKGROUND

A vehicle includes a body having body panels. At least some of the body panels have exterior surfaces that define the exterior surface of the vehicle. The body panels include, e.g., a rear bumper, a front bumper, a roof panel, doors, fenders, a hood, a decklid, etc. Another example of a body panel is a running board, which assists ingress and egress of vehicle passengers into a passenger cabin. The running board includes a surface upon which the passenger can step to step into the passenger cabin.

The running board may be selectively extendable and retractable relative to other body panels of the vehicle. In a retracted position, the running board may be recessed into and/or positioned below the body of the vehicle to improve fuel efficiency while the vehicle is moving. The running board may be moveable outboard and/or downwardly from the body of the vehicle from the retracted position to an extended position when the vehicle is at a stop. In the extended position, the running board is positioned so that a vehicle occupant can step on the running board for ingress and egress.

### BRIEF DESCRIPTION OF THE DRAWINGS

FIG. 1 is a perspective view of a vehicle with a deployable panel, namely a running board, in a stowed position.

FIG. 2 is a perspective view of the vehicle with the deployable panel in a deployed position.

FIG. 3 is a block diagram of a system of the vehicle.

FIG. 4 is a flow chart for a method.

FIG. 5 is a flow chart for a method.

### DETAILED DESCRIPTION

With reference to the Figures, wherein like numerals indicate like parts throughout the several views, a computer 12 includes a processor and memory storing instructions executable by the processor to: predict a potential certain impact to a vehicle 10; in response to prediction of the potential certain impact, move a deployable body panel 14 of the vehicle 10 from a stowed position to a deployed position; and with the deployable body panel 14 in the deployed position, detect certain impact of an object with the deployable body panel 14.

The movement of the deployable body panel 14 to the deployed position positions the deployable body panel 14 for earlier detection of certain vehicle impacts. The deployable body panel 14 moves relative to a body of the vehicle 10 from the stowed position to the deployed position, and in the deployed position, the deployable body panel 14 is positioned so that certain impacts with objects will occur at the deployable body panel 14 prior to adjacent body panels of the vehicle 10, thus providing earlier detection of certain impacts. Earlier detection of certain impacts allows for the vehicle 10 to be equipped with occupant-restraint technology that uses the relatively earlier detection and/or allows for operation of occupant-restraint technology, e.g., an airbag 18, based on the relatively earlier detection. For example, the earlier detection provides the use of a relatively larger airbag for which inflation initiates prior to certain vehicle impacts with other body panels of the vehicle 10 based on detection of that impact at the deployable body panel 14. As another example, the size, shape, and or placement of the airbag 18 may be based on the relatively early detection. The earlier detection may allow for dual-stage inflation of the airbag 18.

The deployable body panel 14 is moved from the stowed position to the deployed position based on detection of the potential of a certain vehicle impact while the vehicle 10 is moving. If the certain vehicle impact does occur, then the airbag 18 is deployed. In the event certain vehicle impact does not occur, e.g., a condition is not satisfied such as a predetermined period of time passes with no detection of the certain vehicle impact, the deployable body panel 14 is moved from the deployed position to the stowed position to increase fuel economy of the vehicle 10. The operation of the deployable body panel 14 between the stowed position and the deployed position is resettable, i.e., in the event potential of a certain vehicle impact is again detected, the deployable body panel 14 is again moved from the stowed position to the deployed position, and again is moved from the deployed position to the stowed position in the event that certain impact is not detected.

In some examples, the deployable body panel 14 may be a running board 20, as shown in the example in the Figures. In other examples, the deployable body panel 14 may be a front bumper, a rear bumper, etc.

The vehicle 10 includes a computer 12, described further below, that controls the operation of the deployable body panel 14. The computer 12 may be, for example, a body control module and/or a restraint control module.

The vehicle 10 may be any suitable type of ground vehicle, e.g., a passenger or commercial automobile such as a sedan, a coupe, a truck, a sport utility, a crossover, a van, a minivan, a taxi, a bus, etc. The vehicle 10 may define a passenger cabin to house passengers of the vehicle 10. The passenger cabin may extend across the vehicle 10, e.g., from a left side of the vehicle 10 to a right side of the vehicle 10. The passenger cabin includes a front end and a rear end with the front end being in front of the rear end during forward movement of the vehicle 10.

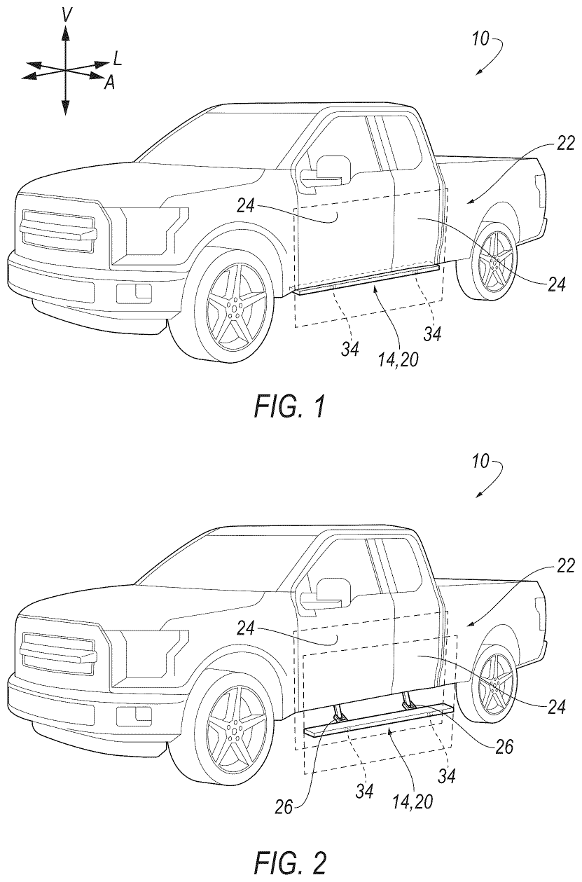

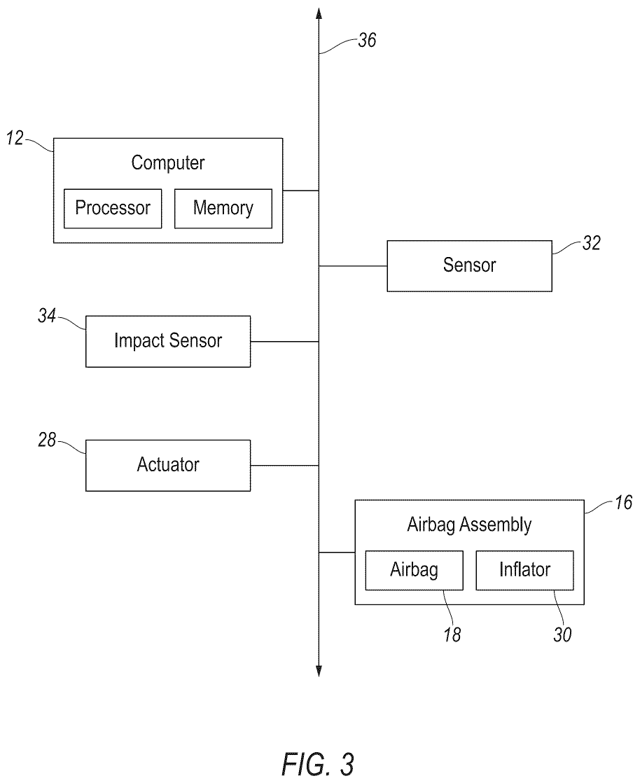

With reference to FIG. 1, the vehicle 10 defines a vehicle-longitudinal axis L extending between a front end (not numbered) and a rear-end (not numbered) of the vehicle 10. The vehicle 10 defines a cross-vehicle axis A extending cross-vehicle from one side to the other side of the vehicle 10. The vehicle 10 defines a vertical axis V extending through a floor and a roof of the vehicle 10. The vehicle-longitudinal axis L, the vehicle-lateral axis A, and the vertical axis V are perpendicular relative to each other.

The vehicle 10 may include a vehicle frame. The vehicle frame may be of a unibody construction in which the vehicle frame is unitary with the vehicle body 22 (including frame rails, pillars, roof rails, etc.). As another example, the vehicle body 22 and the vehicle frame may have a body-on-frame construction (also referred to as a cab-on-frame construction) in which the vehicle body 22 and the vehicle frame are separate components, i.e., are modular, and the vehicle body 22 is supported on and affixed to the vehicle frame. Alternatively, the vehicle frame and vehicle body 22 may have any suitable construction. The vehicle frame and the vehicle body 22 may be of any suitable material, for example, steel, aluminum, and/or fiber-reinforced plastic, etc.

As set forth above, the vehicle body 22 includes body panels. At least some of the body panels have exterior surfaces that define the exterior surface of the vehicle 10. The exterior surfaces may be class-A surfaces, e.g., a finished surface exposed to view by a customer and free of unaesthetic blemishes and defects. The body panels include, e.g., a rear bumper, a front bumper, a roof panel, doors, fenders, a hood, a decklid, a running board 20, etc.

Several of the body panels are fixed body panels 24, and at least one of the body panels may be a deployable body panel 14. The fixed body panels 24 remain stationary relative to each other while the vehicle 10 is driven. In the example shown in FIGS. 1 and 2, the fixed body panels 24 include doors, fenders, and rockers. The deployable body panel 14 is selectively moveable relative to the fixed body panels 24 while the vehicle 10 is driven, as described herein. Specifically, the deployable body panel 14 is selectively moveable relative to adjacent fixed body panels 24, i.e., fixed body panels 24 that are adjacent the deployable body panel 14. As one example, in the example shown in the Figures, the deployable body panel 14 is a running board 20 and the adjacent fixed body panels 24 include two doors adjacent to and above the running board 20.

The deployable body panel 14 is movably connected to the rest of the vehicle body 22, i.e., to another component of the vehicle body 22, and/or the vehicle frame, e.g., a vehicle rocker. The moveable connection between the deployable body panel 14 and the rest of the vehicle body 22 and/or vehicle frame allows the deployable body panel 14 to selectively move relative to adjacent fixed body panels 24 between the stowed position and the deployed position, i.e., from the stowed position to the deployed position and from the deployed position to the stowed position. A joint 26 connects the deployable body panel 14 to the rest of the vehicle body 22 and/or vehicle frame. The joint 26 may allow for linear movement and/or rotational movement of the deployable body panel 14 to the rest of the vehicle body 22 and/or vehicle frame. In other words, the joint 26 may be a linear joint 26 and/or a rotational joint 26.

An actuator 28 moves the deployable body panel 14 relative to the rest of the vehicle body 22 and/or vehicle frame. The actuator 28 may be, for example, a motor. The motor may be, for example, an electric motor, a pneumatic motor, a hydraulic motor, etc. The actuator 28 may be a linear actuator and/or a rotational actuator. In examples in which the actuator 28 is a linear actuator, the actuator 28 moves the deployable body panel 14 to the rest of the vehicle body 22 and/or vehicle frame in a linear motion. In examples in which the actuator 28 is a rotational actuator, the deployable body panel 14 to the rest of the vehicle body 22 and/or vehicle frame in a rotational motion. In some examples, the actuator 28 may move the deployable body panel 14 linearly in a vehicle-outboard/inboard direction, linearly in an up/down direction, and/or rotationally (e.g., about an axis parallel to the vehicle-longitudinal axis L). A computer 12 of the vehicle 10, e.g., the computer 12, can instruct the actuator 28 to move the deployable body panel 14 between the stowed position and the deployed position. The computer 12 may instruct the actuator 28 to move the deployable body panel 14 based on detection of potential certain vehicle impact and based on lack of detection of a vehicle impact after detection of potential certain vehicle impact.

In some examples, the computer 12 may instruct the actuator 28 to move the deployable body panel 14 based on other inputs, such as user-selected inputs. For example, in examples in which the deployable body panel 14 is a running board 20, the computer 12 may instruct the actuator 28 to move the running board 20 from the stowed position to the deployed position for passenger ingress/egress and to move from the deployed position to the stowed position when ingress/egress does not occur, e.g., while the vehicle 10 is driven.

The vehicle 10 includes at least one airbag assembly 16 including an airbag 18. The airbag assembly 16 includes an inflator 30 and may include a housing. The inflator 30 inflates the airbag 18 to the inflated position. In examples including the housing, the housing houses the airbag 18 in the uninflated position and supports the airbag 18 in the inflated position. The airbag 18 may be rolled and/or folded to fit within the housing in the uninflated position. The housing may be of any suitable material, e.g., a rigid polymer, a metal, a composite, or a combination of rigid materials. The airbag housing may, for example, include clips, threaded fasteners, etc., for attaching the housing to the floor. The airbag assembly 16 may be located at any position in the passenger cabin, and the airbag 18 may be of any suitable size and shape. As examples, the airbag assembly 16 may be a curtain airbag, a seat-mounted airbag (e.g., a side airbag), a driver airbag, a passenger airbag, etc. The computer 12 may activate the inflator 30, e.g., provide an impulse to a pyrotechnic charge of the inflator 30 when the impact sensor 34 senses certain vehicle impacts and/or when other conditions are met.

The airbag 18 may be fabric, e.g., a woven polymer yarn. The woven polymer yarn may be, for example, nylon 6, 6. Other examples of the woven polymer yarn include polyether ether ketone (PEEK), polyetherketoneketone (PEKK), polyester, etc. The woven polymer yarn may include a coating, such as silicone, neoprene, urethane, etc. For example, the coating may be polyorgano siloxane.

The inflator 30 is in fluid communication with the airbag 18. The inflator 30 expands the airbag 18 with inflation medium, such as a gas, to move the airbag 18 from the uninflated position to the inflated position. The inflator 30 may be supported by any suitable component. For example, the inflator 30 may be supported by the housing. The inflator 30 may be, for example, a pyrotechnic inflator that ignites a chemical reaction to generate the inflation medium, a stored gas inflator that releases (e.g., by a pyrotechnic valve) stored gas as the inflation medium, or a hybrid. The inflator 30 may be, for example, at least partially in the inflation chamber to deliver inflation medium directly to the inflation chamber or may be connected to the inflation chamber through fill tubes, diffusers, etc.

The vehicle 10 includes one or more sensors 32 that detect potential certain vehicle impacts. With respect to “potential certain vehicle impacts,” “potential” means that the position and/or trajectory of an object and the vehicle 10 will intersect within a predetermined time (e.g., within 3 seconds) unless the position, speed, acceleration, and/or trajectory of the object and/or the vehicle 10 changes. As set forth further below, “certain” vehicle impacts are impacts of a certain magnitude, direction, etc. Detection of a potential certain vehicle impact may also be referred to as detection of the potential of a certain vehicle impact. The sensors that detect potential certain vehicle impacts may be referred to as pre-impact sensors.

The computer 12 may identify potential certain vehicle impacts to the vehicle 10 based on data received from the sensors 32, e.g., via a communication network of the vehicle 10. The computer 12 may identify potential certain vehicle impacts with image recognition, object detection, trajectory prediction, threat probability analysis, and/or other analysis techniques, including, in some examples, conventional data analysis techniques. The detection of potential certain vehicle impact may include detection of potential certain vehicle impact of any portion of the vehicle 10. In some examples, the detection of potential certain vehicle impact may be potential certain vehicle impact of the deployable body panel 14, e.g., the running board 20.

The sensors 32 that detect potential certain vehicle impacts, e.g., pre-impact sensors, may detect the external world, e.g., objects and/or characteristics of surroundings of the vehicle 10, such as other vehicles, road lane markings, traffic lights and/or signs, road users, etc. For example, the sensors 32 may include radar sensors, ultrasonic sensors, scanning laser range finders, light detection and ranging (lidar) devices, and image processing sensors such as cameras.

As one example, the sensor 32 may be a lidar device, e.g., a scanning lidar device. A lidar device detects distances to objects by emitting laser pulses at a particular wavelength and measuring the time of flight for the pulse to travel to the object and back. The lidar device can be any suitable type for providing the lidar data on which the vehicle 10 computer 12 can act, e.g., spindle-type lidar, solid-state lidar, flash lidar, etc.

As another example, the sensor 32 may be a radar device. The radar device transmits radio waves and receives reflections of those radio waves to detect physical objects in the environment. The radar device can use direct propagation, i.e., measuring time delays between transmission and reception of radio waves, and/or indirect propagation, i.e., Frequency Modulated Continuous Wave (FMCW) method, i.e., measuring changes in frequency between transmitted and received radio waves.

As another example, the sensor 32 may be an ultrasonic sensor. The ultrasonic sensor measures distances to features of the environment by emitting ultrasonic sound waves and converting the reflected sound into an electrical signal. The ultrasonic sensor may be any suitable type, e.g., a field of view with a comparatively wide horizontal angle and narrow vertical angle.

As another example, the sensor 32 may be a vision-sensing system. The vision-sensing systems may include one or more cameras, CCD image sensors, CMOS image sensors, etc.

The vehicle 10 may include a sensor 32 that measures a kinematic state of the vehicle 10. For example, based on detection of data indicating the kinematic state of the vehicle 10, the computer 12 may categorize the kinematic state of the vehicle 10, e.g., low kinematic state, high kinematic state, etc. A high kinematic state may indicate that the vehicle 10 is sliding on the driving surface. The sensor 32, for example, may be, or may include, an accelerometer. As an example, the vehicle 10 may include an inertia sensor, e.g., an inertial measurement unit (IMU), that measures acceleration of the vehicle body 22 and/or vehicle frame. The IMU outputs measurement of acceleration, orientation, etc., of the vehicle body 22 and/or vehicle frame. The inertia sensor 32 is mounted to the vehicle body 22 and/or vehicle frame, including in conventionally known ways and locations.

The vehicle 10 may include at least one impact sensor 34 for sensing certain vehicle impacts (e.g., impacts of a certain magnitude, direction, etc.). The computer 12 is in communication with the impact sensor 34. The impact sensor 34 is configured to detect certain vehicle impacts. In other words, a “certain vehicle impact” is an impact of the type and/or magnitude for which inflation of the airbag 18 is designed, i.e., “certain” indicates the type and/or magnitude of the impact. The type and/or magnitude of such “certain vehicle impacts” may be pre-stored in the computer 12, e.g., a restraints control module and/or a body control module. Likewise, detection of certain impact of an object with the vehicle 10 by the impact sensor 34 means that the impact sensor 34 is detecting an impact of the type and/or magnitude for which inflation of the airbag 18 is designed. The impact sensor 34 may be of any suitable type, for example, post contact sensors such as accelerometers, pressure sensors, and contact switches. The impact sensor 34 may be located at numerous points in or on the vehicle 10.

At least one impact sensor 34 detects impact to the deployable body panel 14. In some examples, the impact sensor 34 is supported by the deployable body panel 14, i.e., the weight of the impact sensor 34 is borne by the deployable body panel 14. In such examples, the impact sensor 34 moves with the body panel between the stowed position and the deployed position. In such an example, the impact sensor 34 may detect certain impacts to an exterior surface of the body panel. In examples in which the body panel is a running board 20, the impact sensor 34 may be supported by the running board 20 and moveable with the running board 20 between the stowed position and the deployed position. In other examples, the impact sensor 34 may be between the deployable body panel 14 and another component of the vehicle body 22 and/or vehicle frame. For example, the impact sensor 34 may be at the joint 26. In such an example, the impact sensor 34 detects force on the deployable body panel 14 from certain vehicle impacts.

The computer 12 includes a processor and a memory. The memory includes one or more forms of computer readable media, and stores instructions executable by the processor for performing various operations, including as disclosed herein. For example, the computer 12 can be a generic computer with a processor and memory as described above and/or may include an electronic control unit ECU or controller for a specific function or set of functions, and/or a dedicated electronic circuit including an ASIC that is manufactured for a particular operation, e.g., an ASIC for processing sensor data and/or communicating the sensor data. In another example, the computer 12 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computer 12. The memory can be of any type, e.g., hard disk drives, solid state drives, servers, or any volatile or non-volatile media. The memory can store the collected data sent from the sensors. The memory can be a separate device from the rest of the computer 12, and the computer 12 can retrieve information stored by the memory via a network 36 in the vehicle 10, e.g., over a CAN bus, a wireless network, etc. Use of “in response to,” “based on,” and “upon determining” herein, including with reference to the computer 12 and methods performed by the computer 12, indicates a causal relationship, not merely a temporal relationship.

The vehicle 10 includes a communication network 36 that can include a bus in the vehicle 10 such as a controller area network (CAN) or the like, and/or other wired and/or wireless mechanisms. Via the vehicle network 36, the computer 12 may transmit messages to various devices in the vehicle 10 and/or receive messages (e.g., CAN messages) from the various devices, e.g., sensors, an actuator 28, a human machine interface (HMI), etc. Alternatively or additionally, in cases where the computer 12 actually comprises a plurality of devices, the vehicle communication network 36 may be used for communications between devices represented as the computer 12 in this disclosure. Further, as mentioned below, various controllers and/or sensors may provide data to the computer 12 via the vehicle communication network 36.

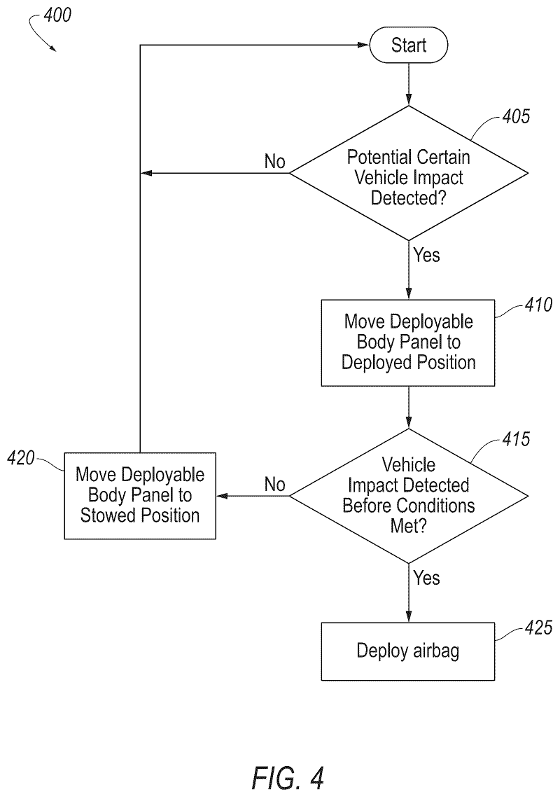

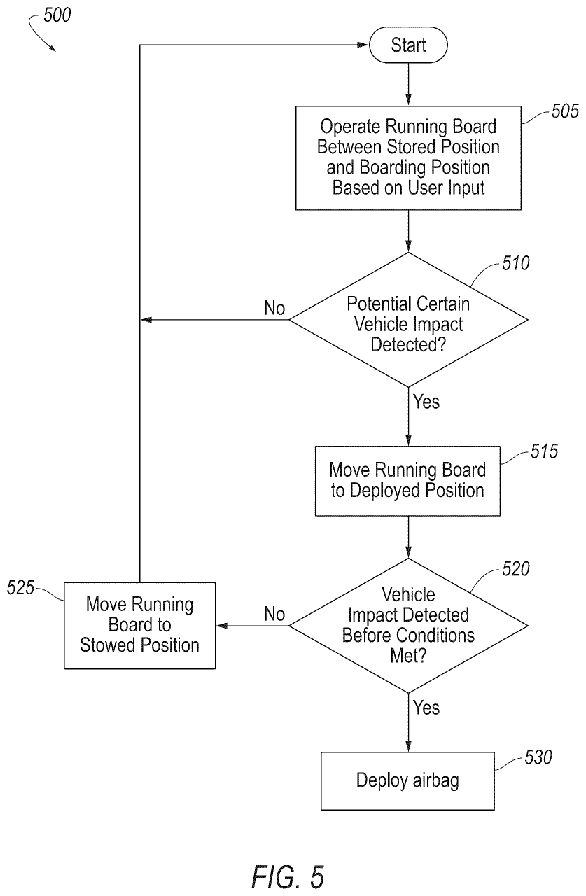

The memory of the computer 12 stores instructions executable by the processor to perform the method 400 shown in FIG. 4 and/or the method 500 shown in FIG. 5.

The memory may store instructions to selectively move the deployable body panel 14 during operation of the vehicle 10 in the absence of detection of potential certain vehicle impacts. As an example, in the example in which the deployable body panel 14 is a running board 20, the memory stores instructions to move the running board 20 to a boarding position in response to user input. For example, user input may include intended occupant ingress to or egress from the vehicle 10. Examples include placing the vehicle 10 in Park, opening/closing a door of the vehicle 10, input through a human-machine interface such as a button, touch screen, etc. In some examples, the boarding position is different than the deployed position (i.e., the position to which the running board 20 moves in response to detection of potential certain vehicle impacts). In other examples, the boarding position is the same as the deployed position. In the example shown in FIG. 2, the boarding position is the same as the deployed position, and the position of the running board 20 in FIG. 2 is both the boarding position and the deployed position.

In the absence of detection of potential certain vehicle impact, the computer 12 controls the actuator 28 to move the running board 20 between the stowed position and the boarding position in response to occupant input. As an example, the computer 12 may move the running board 20 to the boarding position when the vehicle 10 is in Park and a door is opened and may move the running board 20 to the stowed position when the door is closed or when the vehicle 10 is engaged in a Drive setting.

The memory stores instructions to predict a potential certain vehicle impact. As set forth above, the computer 12 may predict a potential certain vehicle impact with image recognition, object detection, trajectory prediction, threat probability analysis, and/or other analysis techniques, including, in some examples, conventional data analysis techniques. The prediction of potential certain vehicle impact may be based on detection by the sensor 32, which detects the position and/or trajectory of an object relative to the vehicle 10, as set forth above. In addition or in the alternative, the prediction of potential certain vehicle impact may be based on the kinematics of the vehicle 10, e.g., as measured by the IMU. For example, the computer 12 may predict a potential certain vehicle impact in response to measurement by the IMU of data indicating that the vehicle 10 is in a high-kinematic state.

The memory stores instructions to, in response to prediction of the potential certain impact, move the deployable body panel 14 of the vehicle 10 from the stowed position to the deployed position. As an example, the computer 12 may instruct the actuator 28 to move the deployable body panel 14 from the stowed position to the deployed position. In some examples, the instructions include instructions to select the location of the deployable body panel 14 relative to adjacent vehicle body panels in the deployed position based on a predicted trajectory of the object relative to the vehicle 10. Specifically, the computer 12 may vary the relative position of the deployable body panel 14 relative to adjacent body panels based on a predicted trajectory of the object relative to the vehicle 10 to increase the potential for early detection of vehicle impact. In such examples, the computer 12 may move the deployable panel linearly in a vehicle-outboard/inboard direction, linearly in an up/down direction, and/or rotationally (e.g., about an axis parallel to the vehicle-longitudinal axis L).

The memory stores instructions to, after the deployable body panel 14 is moved to the deployed position, move the deployable body panel 14 from the deployed position to the stowed position if conditions are met. As one example, the condition may be passage of a predetermined period of time after reaching the deployed position in the absence of detection of certain impact of an object with the deployable body panel 14. In other words, if a vehicle impact is not detected within a predetermined time after the deployable body panel 14 has moved to the deployed position, the computer 12 instructs the actuator 28 to move the deployable body panel 14 from the deployed position to the stowed position. The predetermined period of time may be determined empirically to correspond to the elimination of the potential of the originally detected potential certain vehicle impact. As another example, the condition may be detection of reduction or elimination in the potential for certain vehicle impact by the sensor.

The memory stores instructions to with the deployable body panel 14 in the deployed position, detect a certain impact of an object with the running board 20. The instructions to detect certain impact of an object with the deployable body panel 14 may include instructions to receive input from a sensor in contact with the deployable body panel 14. In such an example, the sensor may be an impact sensor 34 on the deployable body panel 14, as described above. As another example, the impact sensor 34 may detect movement of the deployable body panel 14 relative to a body of the vehicle 10. In such an example, the sensor may be at the joint 26, and in such an example may be an impact sensor 34.

The instructions include instructions to operate an airbag 18 of the vehicle 10 based on detection of certain impact of an object with the deployable body panel 14. For example, the computer 12 may activate the inflator 30, e.g., provide an impulse to a pyrotechnic charge of the inflator 30 when the impact sensor 34 senses certain vehicle impacts and/or when other conditions are met.

With reference to FIGS. 4 and 5, methods 400 and 500 include predicting a potential vehicle impact; in response to prediction of a potential certain vehicle impact, moving a deployable body panel 14 of a vehicle 10 from a stowed position to a deployed position; with the deployable body panel 14 in the deployed position, detecting certain impact of an object with the deployable body panel 14.

With reference to FIG. 4, method 400 includes detecting potential certain vehicle impact, as shown in block 405. As set forth above, potential certain vehicle impact may be detected by the sensor 32, examples of which may be radar sensors, ultrasonic sensors, scanning laser range finders, light detection and ranging (lidar) devices, and image processing sensors such as cameras. Based on data from the sensor, the computer 12 may identify potential certain vehicle impacts with image recognition, object detection, trajectory prediction, threat probability analysis, and/or other analysis techniques, including, in some examples, conventional data analysis techniques. As another example, predicting a potential certain vehicle impact may be in response to measurement by the IMU of data indicating that the vehicle 10 is in a high-kinematic state, as described above.

In block 410, the method includes moving the deployable body panel 14 to the deployed position based on detection of potential certain vehicle impact. As an example, the computer 12 may provide instruction to the actuator 28 to move the deployable body panel 14 from the stowed position to the deployed position in response to detection of potential certain vehicle impact. In the absence of detection of potential certain vehicle impact, the deployable body panel 14 may be maintained in the stowed position (absent movement of the deployable body panel 14 based on user input such as that described in method 500). In some examples, the method 400 may include selecting the location of the deployable body panel 14 relative to the vehicle body 22 in the deployed position based on a predicted trajectory of the object relative to the vehicle 10, as described above.

In block 415, the method 400 includes determining whether vehicle impact is detected before conditions are met in the absence of detection of certain impact of an object with the deployable body panel 14. In block 420, in the event that vehicle impact is not detected by the impact sensor 34 before a condition is met, the method 400 includes moving the deployable body panel 14 to the stowed position. As one example, the condition may include a passage of predetermined period of time after the deployable body panel 14 reaches the deployed position in the absence of detection of certain impact of an object with the deployable body panel 14. For example, upon detecting the potential certain vehicle impact, the computer 12 can initiate a timer. A duration of the timer can be stored, e.g., in a memory of the computer 12. The duration of the timer can be determined empirically, e.g., based on testing that allows for determining a maximum amount of time a pre-impact can be detected prior to a vehicle 10 side-impact. In response to not receiving signals from the impact sensor 34 prior to expiration of the timer, the computer 12 can determine that no vehicle impact occurred. In this situation, the computer 12 may initiate actuation of the actuator 28 to return the deployable body panel 14 to the stowed position, absent other input to the contrary such as another detection of potential certain vehicle impact. As another example, the method 400 may include reduction or elimination in the potential for certain vehicle impact by the sensor 32.

Returning to block 415, in the event a certain vehicle impact is detected by the impact sensor 34, the method 400 proceeds to block 425. The vehicle impact may be detected by an impact sensor 34 on the deployable body panel 14, as described above. Detecting certain impact of an object with the deployable body panel 14 includes receiving input from a sensor in contact with the deployable body panel 14. In one example, detecting certain impact of an object with the deployable body panel 14 includes detecting force on the deployable body panel 14 by a sensor on the deployable body panel 14. In such an example, the sensor may be an impact sensor 34 supported by and moveable with the deployable body panel 14, as described above. In another example, detecting certain impact of an object with the deployable body panel 14 includes detecting movement of the deployable body panel 14 relative to the rest of the vehicle body 22, e.g., relative to an adjacent vehicle body panel.

In block 425, the method 400 includes deploying an airbag 18 of the vehicle 10 based on detection of certain impact of an object with the deployable body panel 14. Block 425 may include activating the inflator 30 by providing an impulse to a pyrotechnic charge of the inflator 30 when the impact sensor 34 detects certain vehicle impacts and/or when other conditions are met.

With reference to FIG. 5, the method 500 includes the example in which the deployable body panel 14 is a running board 20. In such an example, the method 500 includes operating the running board 20 between the stowed position and the boarding position based on user input. For example, the method 500 may include moving the running board 20 between the stowed position and the boarding position based on user input that may include intended occupant ingress to or egress from the vehicle 10. Examples include placing the vehicle 10 in Park, opening/closing a door of the vehicle 10, input through a human-machine interface such as a button, touch screen, etc. In the absence of detection of potential certain vehicle impacts, the method 500 controls the position of the running board 20 based on block 505.

The method 500 includes detecting potential certain vehicle impact, as shown in block 510. As set forth above, potential certain vehicle impact may be detected by the sensor, examples of which may be radar sensors, ultrasonic sensors, scanning laser range finders, light detection and ranging (lidar) devices, and image processing sensors such as cameras. Based on data from the sensor, the computer 12 may identify potential certain vehicle impacts with image recognition, object detection, trajectory prediction, threat probability analysis, and/or other analysis techniques, including, in some examples, conventional data analysis techniques. As another example, predicting a potential certain vehicle impact may be in response to measurement by the IMU of data indicating that the vehicle 10 is in a high-kinematic state, as described above.

In block 515, the method 500 includes moving the running board 20 to the deployed position based on detection of potential certain vehicle impact. As an example, the computer 12 may provide instruction to the actuator 28 to move the running board 20 from the stowed position to the deployed position in response to detection of potential certain vehicle impact. In the absence of detection of potential certain vehicle impact, the running board 20 may be maintained in the stowed position (absent movement of the deployable body panel 14 based on user input such as that described in method 500). In some examples, the method 500 may include selecting the location of the running board 20 relative to the vehicle body 22 in the deployed position based on a predicted trajectory of the object relative to the vehicle 10, as described above.

In block 520, the method 500 includes determining whether vehicle impact is detected before conditions are met in the absence of detection of certain impact of an object with the running board 20. In block 420, in the event that vehicle impact is not detected by the impact sensor 34 before a condition is met, the method 400 includes moving the running board 20 to the stowed position. As one example, the condition may include a passage of predetermined period of time after the running board 20 reaches the deployed position in the absence of detection of certain impact of an object with the running board 20. For example, upon detecting the potential certain vehicle impact, the computer 12 can initiate a timer. A duration of the timer can be stored, e.g., in a memory of the computer 12. The duration of the timer can be determined empirically, e.g., based on testing that allows for determining a maximum amount of time a pre-impact can be detected prior to a vehicle 10 side-impact. In response to not receiving signals from the impact sensor 34 prior to expiration of the timer, the computer 12 can determine that no vehicle impact occurred. In this situation, the computer 12 may initiate actuation of the actuator 28 to return the deployable body panel 14 to the stowed position, absent other input to the contrary such as another detection of potential certain vehicle impact. As another example, the method 400 may include reduction or elimination in the potential for certain vehicle impact by the sensor.

Returning to block 520, in the event a certain vehicle impact is detected by the impact sensor 34, the method 500 proceeds to block 530. The vehicle impact may be detected by an impact sensor 34 on the running board 20, as described above. Detecting certain impact of an object with the running board 20 includes receiving input from a sensor in contact with the running board 20. In one example, detecting certain impact of an object with the running board 20 includes detecting force on the deployable body panel 14 by a sensor on the running board 20. In such an example, the sensor may be an impact sensor 34 supported by and moveable with the running board 20, as described above. In another example, detecting certain impact of an object with the running board 20 includes detecting movement of the deployable body panel 14 relative to the rest of the vehicle body 22, e.g., relative to an adjacent vehicle body panel.

In block 530, the method 500 includes deploying an airbag 18 of the vehicle 10 based on detection of certain impact of an object with the running board 20. Block 530 may include activating the inflator 30 by providing an impulse to a pyrotechnic charge of the inflator 30 when the impact sensor 34 detects certain vehicle impacts and/or when other conditions are met.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and memory storing instructions executable by the processor to:
predict a potential certain impact to a vehicle;
in response to prediction of the potential certain impact, move a deployable body panel of the vehicle from a stowed position to a deployed position; and
with the deployable body panel in the deployed position, detect a certain impact of an object with the running board.

2. The computer as set forth in claim 1, wherein the instructions to detect certain impact of an object with the deployable body panel include instructions to receive input from a sensor in contact with the deployable body panel.

3. The computer as set forth in claim 1, wherein the instructions to detect certain impact of an object with the deployable body panel include instructions to receive an indication of detection of force on the deployable body panel by a sensor on the deployable body panel.

4. The computer as set forth in claim 1, wherein the instructions to detect certain impact of an object with the deployable body panel include instructions to receive an indication of detection of movement of the deployable body panel relative to a body of the vehicle.

5. The computer as set forth in claim 1, wherein the instructions include instructions to deploy an airbag of the vehicle based on detection of certain impact of an object with the deployable body panel.

6. The computer as set forth in claim 1, wherein the deployable body panel is a running board, and the instructions include instructions to move the running board to a boarding position in response to intended occupant ingress to or egress from the vehicle.

7. The computer as set forth in claim 6, wherein the boarding position is different than the deployed position.

8. The computer as set forth in claim 1, wherein the instructions include instructions to select the location of the deployable body panel relative to the vehicle body in the deployed position based on a predicted trajectory of the object relative to the vehicle.

9. The computer as set forth in claim 1, wherein the instructions include instructions to move the deployable body panel from the deployed position to the stowed position when a condition is met and in the absence of detection of certain impact of an object with the deployable body panel.

10. The computer as set forth in claim 9, wherein the condition includes a passage of predetermined period of time after the deployable body panel reaches the deployed position in the absence of detection of certain impact of an object with the deployable body panel.

11. A method comprising:
predicting a potential vehicle impact;
in response to prediction of a potential certain vehicle impact, moving a deployable body panel of a vehicle from a stowed position to a deployed position;
with the deployable body panel in the deployed position, detecting certain impact of an object with the deployable body panel.

12. The method as set forth in claim 11, wherein detecting certain impact of an object with the deployable body panel includes receiving input from a sensor in contact with the deployable body panel.

13. The method as set forth in claim 11, wherein detecting certain impact of an object with the deployable body panel includes detecting force on the deployable body panel by a sensor on the deployable body panel.

14. The method as set forth in claim 11, wherein detecting certain impact of an object with the deployable body panel includes detecting movement of the deployable body panel relative to a body of the vehicle.

15. The method as set forth in claim 11, further comprising deploying an airbag of the vehicle based on detection of certain impact of an object with the deployable body panel.

16. The method as set forth in claim 11, wherein the deployable body panel is a running board, and further comprising moving the running board to a boarding position in response to intended occupant ingress to or egress from the vehicle.

17. The method as set forth in claim 16, wherein the boarding position is different than the deployed position.

18. The method as set forth in claim 11, further comprising selecting the location of the deployable body panel relative to the vehicle body in the deployed position based on a predicted trajectory of the object relative to the vehicle.

19. The method as set forth in claim 11, further comprising moving the deployable body panel from the deployed position to the stowed position when a condition is met and in the absence of detection of certain impact of an object with the deployable body panel.

20. The method as set forth in claim 19, wherein the condition includes a passage of predetermined period of time after the deployable body panel reaches the deployed position in the absence of detection of certain impact of an object with the deployable body panel.
